(19) United States
(12) Patent Application Publication
(10) Pub. No.: US 2009/0276654 A1
(43) Pub. Date: Nov. 5, 2009

(54) SYSTEMS AND METHODS FOR IMPLEMENTING FAULT TOLERANT DATA PROCESSING SERVICES

(75) Inventors: Henry Esmond Butterworth, Hampshire (GB); Thomas Van Der Veen, HANTS (GB)

Correspondence Address: KEUSEY, TUTUNJIAN & BITETTO, P.C., 20 CROSSWAYS PARK NORTH, SUITE 210, WOODBURY, NY, 11797, US

(73) Assignee: INTERNATIONAL BUSINESS MACHINES CORPORATION, ARMONK, NY (US)

(21) Appl. No.: 12/114,549

(22) Filed: May 2, 2008

(51) Int. Cl. G06F 11/00

(52) U.S. Cl. 714/1; 714/E11.144

(57) ABSTRACT

Systems and methods are provided to implement fault tolerant data processing services based on active replication and, in particular, systems and methods for implementing actively replicated, fault tolerant database systems in which database servers and data storage servers are run as isolated processes co-located within the same replicated fault tolerant context to provide increased database performance.

### TECHNICAL FIELD

Embodiments of the invention relate to systems and methods for providing fault tolerant data processing services in a fault tolerant context based on active replication and, in particular, systems and methods for implementing actively replicated, fault tolerant database systems in which database servers and data storage servers are run as isolated processes co-located within the same replicated fault tolerant context to provide increased database performance.

### BACKGROUND

In general, various data processing applications such as database applications require access to fault-tolerant stable storage services on performance critical paths Database systems are typically implemented using a database server and a storage server which run on separate physical nodes In database systems, the storage server is typically protected from the database server such that if the database server fails and is recovered, the database can be recovered from the data stored on the storage server. In order to correctly recover from a database server failure, the data stored on the storage server can not be corrupted by virtue of the database failure. In general, data can be protected by deploying a storage server with no single point of failure using various fault tolerant techniques.

A common method for implementing fault tolerance involves replicating a process or service in a distributed system to provide redundancy, wherein each replica keeps a consistent state by implementing specific replication management protocols. For example, in replicated database applications, a storage server can be configured to maintain redundant copies of the data in multiple hardware failure domains (or storage server nodes). By way of specific example, a database might run on a UNIX machine and the storage server might be a direct or SAN (storage area network) attached RAID controller with a mirrored non-volatile fast write cache. The storage server will use the cache to provide storage services, wherein cache data and dirty cache data must be consistently maintained in multiple failure domains.

There are certain performance disadvantages associated with conventional frameworks for replicated database systems. For example, in conventional frameworks where database and storage servers reside on different physical nodes, there can be significant overhead associated with the inter-node communication latency between database and storage servers. In particular, databases typically execute transactions, which include a set of data-dependent operations that can include some combination of retrieval, update, deletion or insertion operations. In this regard, a single database transaction can require inter-node communication of multiple requests from the database server to the storage server, thereby introducing significant communication latency into the critical path for the execution of database transactions.

Moreover, conventional database systems that implement replication for fault tolerance can suffer in performance due to the latency of the communication required to mirror cache data between storage server nodes. Indeed, there are inherent costs associated with maintaining consistency in replicated databases, because the updating of data items requires the propagation of at least one message to every replica of that data item, thereby consuming substantial communications resources. The integrity of the data can be compromised if the replicated database system cannot guarantee data consistency among all replicas.

### SUMMARY OF THE INVENTION

Exemplary embodiment of the invention generally include systems and methods for providing fault tolerant data processing services in a fault tolerant context based on active replication. In one exemplary embodiment of the invention, a method for implementing a fault tolerant computing system includes providing a cluster of computing nodes providing independent failure domains, running a data processing service on the cluster of computing nodes within a fault tolerant context implemented using active replication wherein replicas of the data processing service independently execute in parallel on a plurality of the computing nodes. In one exemplary embodiment, the data processing service comprises a data access service to handle client requests for access to data and a data storage service that provides stable storage services to the data access service, wherein the data access and storage services run as separate, isolated processes co-located in a replicated fault tolerant context over the computing nodes, and wherein the data access service and data storage service communicate through inter-process communication.

In another exemplary embodiment of the invention, an actively replicated, fault tolerant database system is provided in which a database server and data storage server run as isolated processes co-located within the same replicated fault tolerant context to provide increased database performance. More specifically, in one exemplary embodiment, a fault tolerant database system can be implemented using an active replication fault tolerant framework which uses a replicated state machine approach to provide a general purpose fault-tolerant replicated context with support for memory protection between processes.

Under the active replication fault tolerant database framework, a database server and storage server (e.g., storage service cache or an entire storage service) run as separate, isolated processes co-located within the same replicated fault tolerant context over a plurality of computing node providing independent failure domains. In the replicated framework, the input to the database server is run through a distributed consensus protocol where all subsequent execution occurs independently in parallel on all replicas without the need for further inter-node communication between the database and storage servers as all subsequent communication is implemented via inter-process communication within the replicas. Since the separate processes are memory protected from each other via isolation, if the database server crashes, the database server process can be restarted and recovered using the data committed to the storage server process.

The invention differs from the normal architecture of separate physical database server and storage server because, whilst it introduces a small amount of incremental messaging latency to run the input database request through the distributed consensus protocol of the replicated state machine infrastructure, it reduces the latency of the database-server to storage-server communication to that of inter-process communication and entirely eliminates the requirement for any additional inter-storage-server-node communication overhead required for fault-tolerance of the storage server (the equivalent of this function is contained in the up-front messaging of the distributed consensus protocol). Since there are typically several storage-service requests for each database request, this trade-off has a performance advantage.

In the exemplary active replication framework, by executing the database server process in the same replicated fault tolerant context of the storage server process, the inter-node communication latency between the database and storage server processes is significantly reduced to that of inter-process communication (as opposed to the inter-node communication latency that exists in conventional systems). Moreover, the implementation of the replicated state machine approach provides a no-single point of failure implementation for the storage service, and eliminates latency associated with communication between replicated storage server nodes as in conventional frameworks to required to mirror the cache data between the storage-server nodes.

These and other exemplary embodiments, features and advantages of the present invention will be described or become apparent from the following detailed description of exemplary embodiments, which is to be read in connection with the accompanying drawings.

### BRIEF DESCRIPTION OF THE DRAWINGS

FIGS. 1A and 1B are high-level block diagrams of fault tolerant computing systems having an active replication framework in which exemplary embodiments of the invention may be implemented.

FIG. 2 is a high level block diagram of a system that provides fault tolerant data processing services using an active replication framework according to an exemplary embodiment of the invention.

FIG. 3 is a high level block diagram of a fault tolerant database system using an active replication framework according to an exemplary embodiment of the invention.

FIG. 4 is a high level block diagram of a fault tolerant database system using an active replication framework according to another exemplary embodiment of the invention

FIGS. 5A and 5B are high-level block diagrams of a fault tolerant database system having an active replication framework according to another exemplary embodiment of the invention.

### DETAILED DESCRIPTION OF EXEMPLARY EMBODIMENTS

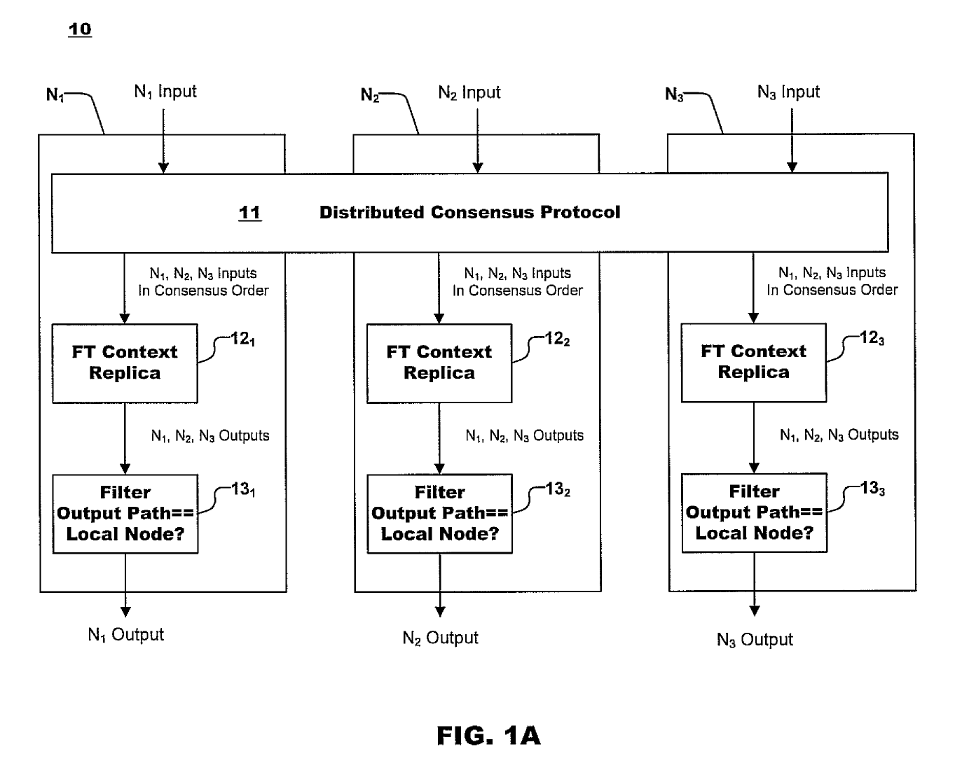

Exemplary embodiments of systems and methods for providing fault tolerant data processing systems will now be discussed in further detail with reference to the Figures. In general, fault tolerant data processing services according to exemplary embodiments of the invention are implemented using active replication fault tolerant frameworks in which a data access service (e.g., database server) and a data storage service (storage server) in each replica are run as isolated processes co-located within the same replicated fault tolerant context. FIGS. 1A and 1B are high-level block diagrams of fault tolerant computing systems having an active replication based framework in which exemplary embodiments of fault tolerant data processing services according to exemplary embodiments may be implemented as discussed in further detail hereafter.

Referring initially to FIG. 1A, a computing system (10) is shown which comprises a cluster of computing nodes N1, N2 and N3 that serve as independent failure domains for running replicas of a data processing service through active replication methods implemented using fault tolerance management software. More specifically, the system (10) includes a distributed consensus protocol module (11) that runs over all nodes N1, N2, N3 in the cluster, and a plurality of replicas (121, 122, 123) and filter modules (131, 132, 133) that run independently on respective nodes N1, N2 and N3. The system (10) provides fault tolerant service through n-way active replication of a deterministic data processing service/process where each replica (121, 122, 123) independently executes in parallel on a different failure domain (e.g., nodes N1, N2, N3) in parallel.

More specifically, the distributed consensus protocol module (11) implements methods to ensure that each replica (121, 122, 123) receives the same sequence of inputs over all nodes N1, N2, N3 in the same order. An example of a distributed consensus protocol is the PAXOS protocol as described in L. Lamport, The part-time parliament, Technical Report 49, DEC SRC, Palo Alto, 1989. The same sequence of node inputs is passed to all replicas (121, 122, 123) at the input boundary of the replicated fault-tolerant context. Since each replica receives the same input sequence, and starts in the same state and is deterministic, each replica (121, 122 123 ) produces the same sequence of outputs at the output boundary of the replicated fault-tolerant context. The output of the replicas contains the information specifying which node must actually action the output. The filters (131, 132 133) process the outputs of the respective replicas (121, 122 123) and one node actions the output, the remaining nodes do nothing. Since the output of each replica is the same for all replicas, fault tolerance is essentially achieved because one copy of the state of the service is held by each replica so it does not matter if a subset of the replicas fail since a copy of the service state will be retained in a surviving replica.

FIG. 1B is a conceptual illustration of the computing system (10) of FIG. 1A implemented as a single fault-tolerant virtual machine which receives input over a plurality of redundant input paths (14) and outputs data over a plurality of redundant output paths (15). From a programming perspective, the virtual machine implementation can hide most details regarding replication. The FTVM has redundant connections to the outside world (one connection through each node running a replica) and can use multi-pathing software to fail-over when paths are lost due to node failure. Outside the replication boundary, all communication to the virtual machine is passed through the distributed consensus protocol (11) and committed to a sequence of inputs that is processed by all replicas. All communication from the fault-tolerant virtual machine (10) is made through a specific node chosen by the fault-tolerant virtual machine (10). If a peripheral is accessible from multiple nodes, then the virtual machine (10) will see multiple redundant paths to the peripheral and may use multi-pathing software to perform path failover when a node fails.

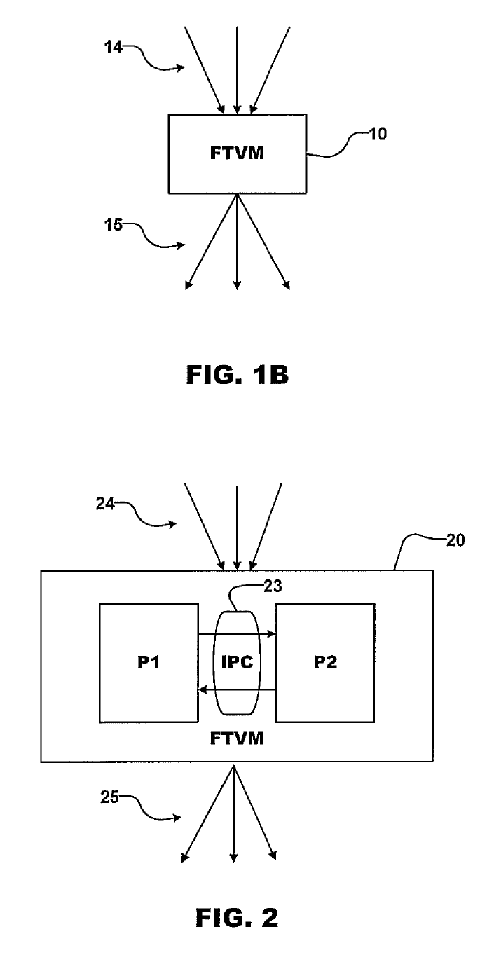

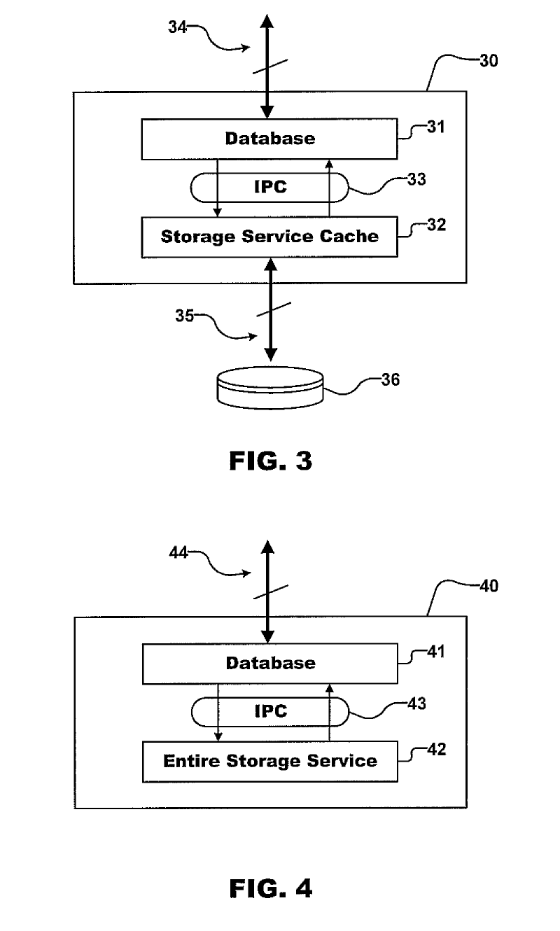

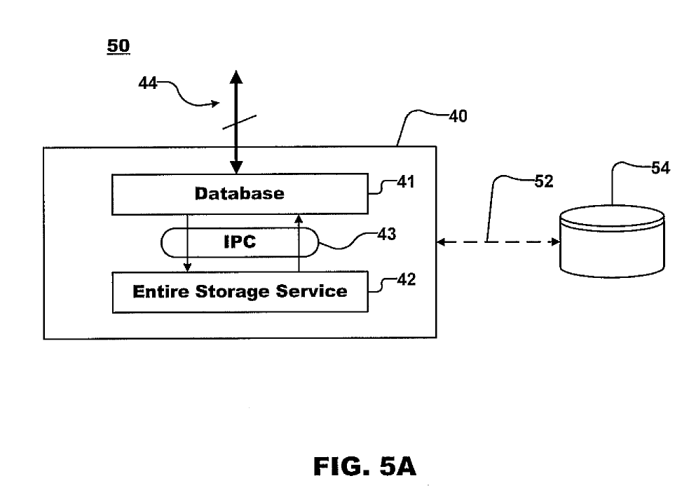

FIG. 2 is a high level block diagram of a fault tolerant data processing system that provides fault tolerant data processing services using an active replication framework based on the frame work of FIGS. 1A and 1B, according to an exemplary embodiment of the invention. FIG. 2 depicts a fault tolerant virtual machine (20) in which a fault tolerant data processing service is implemented by running isolated processes (21) and (22) that are co-located within the same fault tolerant context and which communicate with each other using inter-process communication (IPC) methods (23). In accordance with exemplary embodiments of the invention, the first process (21) may be any data access process which requires fault tolerant stable storage services to perform data access operations and the second process (22) may be any process that provides fault tolerant storage services to the data access process (21) on a performance critical path. In one specific exemplary embodiment, in the context of a database application, the process (21) may be a database server while process (22) may be a storage server, exemplary embodiments of which will be described below with reference to FIGS. 3 and 4, for example.

The FTVM (20) implements an active replication fault tolerant framework with a plurality of redundant input paths (24) and redundant output paths (25). The fault tolerant virtual machine (20) may be configured to run a general purpose operating system with memory protection, wherein fault tolerance is implemented using active replication and where the operating system (OS) in the FT context runs processes (21) and (22) with protection from each other and inter-process communication (IPC) facility. Some operating systems (OSs) provide process isolation and inter-process communication. Many operating systems include means for isolating processes so that a given process cannot access or corrupt data or executing instructions of another process. In addition, isolation provides clear boundaries for shutting down a process and reclaiming its resources without cooperation from other processes. The use of inter-process communication allows different processes, which run as isolated processes in the same replicated fault tolerant context, to exchange data and events.

There are various techniques that may be utilized to support isolation between processes with the same fault tolerant context. For example, if the FT context ABI (application binary interface) is designed to be compatible with the ABI expected by the OS with support for isolation, then the FT context would be able to run that OS. For example, if the FT context looked like an x86 PC, then it could run Linux or Windows, for example, which support isolated processes. An alternative might be to write a new OS to the ABI of the FTVM (20). In another embodiment, the FTVM can be used to run a hypervisor and the isolated processes are nested virtual machines.

The exemplary embodiments of FIGS. 1A, 1B and 2 provide a general framework upon which a fault tolerant database system can be implemented in a fault tolerant context using active replication. For example, FIGS. 3, 4 and 5A-5B are high-level diagrams that illustrate systems and methods for implementing fault tolerant database systems based on the exemplary frameworks of FIGS. 1A, 1B and 2, wherein a database server and data storage server run as isolated processes (memory protection) within the same replicated fault tolerant context and communicate via inter-process communication. More specifically, in one exemplary embodiment, a fault tolerant database system can be implemented using active replication fault tolerant framework which uses a replicated state machine approach to provide a general purpose fault-tolerant replicated context with support for memory protection between processes.

Under the active replication fault tolerant database framework, a database server and storage server (e.g., storage service cache or an entire storage service) run as separate, isolated processes co-located within the same replicated fault tolerant context over a plurality of computing node providing independent failure domains. In the replicated framework, the input to the database server is run through a distributed consensus protocol where all subsequent execution occurs independently in parallel on all replicas without the need for further inter-node communication between the database and storage servers as all subsequent communication is implemented via inter-process communication within the replicas. Since the separate processes are isolated from each other by memory protection, if the database server crashes, the database server process can be restarted and recovered using the data committed to the storage server process.

In the exemplary active replication framework, although a small amount of incremental messaging latency may result from running the input database request through the distributed consensus protocol of the replicated state machine infrastructure, it reduces the latency of the database-server to storage-server communication to that of inter-process communication and entirely eliminates the requirement for any additional inter-storage-server-node communication overhead required for fault-tolerance of the storage server (the equivalent of this function is contained in the up-front messaging of the distributed consensus protocol). Since there are typically several storage-service requests for each database request, this trade-off has a performance advantage. Indeed, by executing the database server process in the same replicated fault tolerant context of the storage server process, the inter-node communication latency between the database and storage server processes is significantly reduced to that of inter-process communication (as opposed to the inter-node communication latency that exists in conventional systems).

Moreover, the implementation of the replicated state machine approach provides a no-single point of failure implementation for the storage service, and eliminates latency associated with communication between replicated storage server nodes as in conventional frameworks to required to mirror the cache data between the storage-server nodes.

FIG. 3 is a high level block diagram of a fault tolerant database system according to an exemplary embodiment of the invention. More specifically, FIG. 3 illustrates a fault tolerant virtual machine (30) according to an exemplary embodiment of the invention, in which a database server (31) and storage service cache (32) run as isolated processes co-located within the same replicated fault tolerant context and communicate through IPC (33). A plurality of redundant I/O paths (34), which are connected to the database process (31), include input paths for inputting database transaction requests and output paths for outputting database query results. A plurality of I/O paths (35), which are connected between the storage service cache (32) and an external back-end storage device (36) outside of the FT context, include input paths to receive cache stage data and output paths for outputting storage service cache destage data. In the exemplary framework of FIG. 3, all inputs over the redundant inputs paths included in (34) and (35) are processed through the distributed consensus protocol and all output data/results over the output paths in (34) and (35) are processed through the node filters (as discussed above with reference to FIG. 1A.)

FIG. 3 illustrates an exemplary embodiment in which only the cache of the storage server runs in the FT context where cache misses go to external back-end storage (36), which can be employed under circumstances in which there is not enough RAM in the physical machine running each replica of the FT context to store the entire data set for the storage service. The exemplary fault tolerant framework allows for cached data to be effectively n-way mirrored on the storage service cache in each of the replicated fault tolerant contexts over multiple failure domains while eliminating the requirement for any additional inter storage server node communication overhead required to maintain cache consistency for fault-tolerance of the storage server. Moreover, since the database (31) and storage service cache (32) processes run in isolation and are protected from each other, if the database server (31) crashes, it can be restarted and recovered in the normal way using the data committed to the storage service cache in the second process (32).

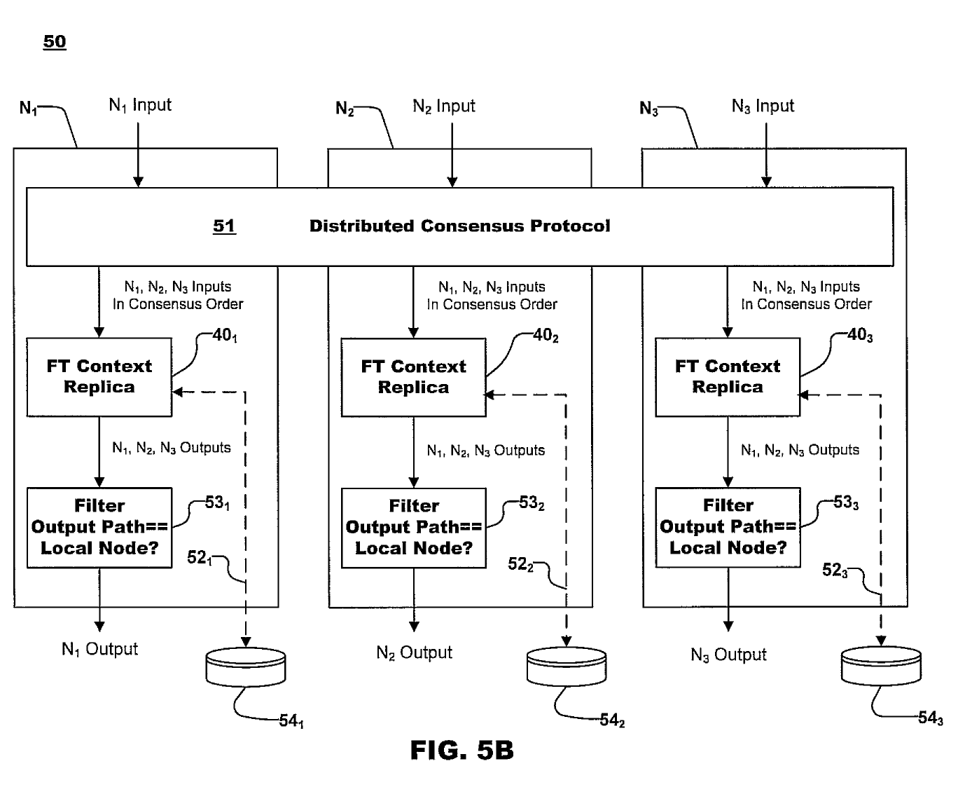

The exemplary framework of FIG. 3 provides performance benefits over conventional systems when the cache read hit ratio is high. However, under cache unfriendly workloads with high cache misses, since data must be read from the external data storage (36) upon cache misses, the read data input to the storage cache (32) must pass through the distributed consensus protocol which has higher overhead per read operation. In this regard, to further enhance database performance, the entire data storage service can be executed in the replicated fault tolerant context using various methods as discussed hereafter with reference to FIGS. 4, 5A and 5B.

FIG. 4 is a high level block diagram of a fault tolerant database system according to another exemplary embodiment of the invention. More specifically, FIG. 4 illustrates a fault tolerant virtual machine (40) providing an active replication fault tolerant framework under which a database server (41) and entire storage service (42) run as isolated processes co-located within the same replicated fault tolerant context and communicate through IPC (43). A plurality of redundant I/O paths (44) include input paths for input database transaction requests and output paths for database query results. In contrast to the FT framework of FIG. 3, no redundant I/O paths to an external storage device (outside of the FT context) is needed as the entire storage service (42) is run in each replicated FT context. Depending on the available resources and system configuration, an entire storage service can be run in the FT context using various methods.

For instance, in the exemplary embodiment of FIG. 4, in circumstances where there is sufficient RAM in the physical machine running each replica of the FT context (40), the entire storage service (42) can be implemented in the FT context (40) using a cache in the RAM of the computing node without having to utilize an external backend storage volume (36) such as shown in FIG. 3. However, the use of the RAM on the computing system may be prohibitively expensive for large data sets. Thus, in other exemplary embodiments of the invention, the entire storage server can be run in the FT context by using a dedicated backing storage volume in each replicated FT context as will discussed hereafter with reference to FIGS. 5A and 5B.

In particular, FIGS. 5A illustrates a fault tolerant database system (50) depicted in the form of a fault tolerant virtual machine (40) similar to FIG. 4 in which a database server (41) and entire storage service (42) run as isolated processes co-located within the same replicated fault tolerant context and communicate through IPC (43), and where a plurality of redundant I/O paths (44) include input paths for input database transaction requests and output paths for database query results. However, in contrast to FIG. 4, the system (50) includes a dedicated back-end storage volume (54) that is connected within the FT context via a virtual connection (52) such that the backing volume (54) can be considered to be an extension of the replica instance. FIG. 5S illustrates the computing system (50) of FIG. 5 in the replicated framework over a cluster of computing nodes N1, N2 and N3 that serve as independent failure domains for running replicas (401, 402, 403) of the FT context (40), and where a distributed consensus protocol module (51) and filter modules (531, 532 533) are implemented for managing the replication protocol for the database service (40) in the FT context. Each replica (401, 402, 403) is connected to a dedicated backing storage volume (541, 542 543), respectively, through a dedicated connection (521, 522 523).

The FT virtual disk (54) can be used by the OS in the FT context (40) in various ways. For instance, the storage service process (42) can have a cache in the FTVM RAM and drive the FT virtual local disk (54) as the backing storage for the cache such that each replica cache can stage and destage from the independent dedicated backing volumes (54₁, 54₂ 54₃). In such instance, where the backing volume is effectively an extension of the replica instance, there is no need for data that is read from the volume to be passed through the distributed consensus protocol (51) as all replicas 40₁, 40₂ 40₃ will read/write all backing volumes 54₁, 54₂, 54₃ independently in parallel and will transfer the same data. In this regard, the overall data set is effectively n-way mirrored on each backing volume (54₁, 54₂, 54₃). In another exemplary embodiment, the storage service process (42) in each replica (40₁, 40₂ 40₃) can be implemented entirely in the virtual address space of the replica, wherein the associated backing volume 40₁, 40₂ 40₃ is used to page that address space to limit the amount of expensive RAM that is required.

In the exemplary embodiment of FIGS. 5A and 5B, the backing volumes (54₁, 54₂ 54₃) may be hard disk drives or hard disk drive arrays or optionally solid state drives or solid state drive arrays. The framework in FIGS. 5A and 5B allows for high performance database operation under general workloads. If the backing volumes (54₁, 54₂, 54₃) are disk drive-based, then it is preferable to use the dedicated back-end storage volumes for each replica to for cache staging and destaging as it is easier to achieve I/O concurrency required for high hard disk drive operation rate with a dedicated cache stage/destage algorithm, as opposed to paging virtual memory.

On the other hand, if the backing volumes (54₁, 54₂, 54₃) are solid state drives where I/O concurrency is not required for high operation rate, then it may be preferable to implement the storage service entirely in the replica's virtual address space so as to simplify the cache implementation and use the dedicated backing volume to page that virtual address space to thereby limit the amount of expensive RAM that is required.

In exemplary embodiments of the invention where the dedicated back end storage volumes (54₁, 54₂, 54₃)are implemented using solid-state storage, for example, FLASH memory, with much lower access latency than rotating disk storage, the performance advantage of the invention over a traditional framework similarly provisioned with solid state storage becomes very significant. Indeed, once latency of the rotating disk is eliminated, communication latencies are the next most significant factor limiting system performance and these latencies are optimized using techniques as described above in accordance with the invention.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention. All such changes and modifications are intended to be included within the scope of the invention as defined by the appended claims.

1. A method for implementing a fault tolerant computing system, comprising:
providing a cluster of computing nodes providing independent failure domains;
running a data processing service on the cluster of computing nodes within a fault tolerant context implemented using active replication wherein replicas of the data processing service independently execute in parallel on a plurality of the computing nodes,
wherein the data processing service comprises a data access service and data storage service, and
wherein running the data processing service comprises running the data access service and data storage service as separate, isolated processes co-located in a replicated fault tolerant context over the computing nodes,
wherein the data access service and data storage service communicate through inter-process communication.
